(19) United States
(12) Patent Application Publication
(10) Pub. No.: US 2007/0217226 A1
(43) Pub. Date: Sep. 20, 2007

(54) LIGHT GUIDE PLATE WITH LIGHT DIFFUSING CUTOUT AND BACKLIGHT MODULE USING THE SAME

(75) Inventors: WEN-WU ZHU, Shenzhen (CN); YE WU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/556,121

(22) Filed: Nov. 2, 2006

(30) Foreign Application Priority Data
Mar. 17, 2006 (TW) 095109257

(51) Int. Cl. F21V 7/04

(52) U.S. Cl. 362/615

(57) ABSTRACT

The present invention discloses a light guide plate (20) including a light incident surface (221), a light emitting surface (222) adjacent to the light incident surface (221), and a light diffusing cutout (223). The light diffusing cutout (223) is defined in the light guide plate near the light incident surface (221). The present invention also provides a backlight module.

### BACKGROUND OF THE INVENTION

1. Field of the Invention

The present invention relates to light guide plates and backlight modules that use light guide plates, and more particularly to a light guide plate configured to have improved optical uniformity, and a backlight module using the same.

2. Discussion of the Related Art

In a liquid crystal display device, the liquid crystal is a substance that does not itself illuminate light. Instead, the liquid crystal relies on receiving light from a light source in order to provide display of data and images. In a typical liquid crystal display device, a backlight module powered by electricity supplies the needed light.

Referring to FIG. 1, a typical backlight module 10 is shown. The backlight module 10 includes a plurality of point light sources 11, a reflective sheet 12, a light guide plate 13, a light diffusion sheet 14, and a prism sheet 15. The light guide plate 13 includes a light incident surface 131, a light emitting surface 132 adjoining the light incident surface 131, and a bottom surface 133 facing an opposite direction of the light emitting surface 131. The light sources 11 are located adjacent to the light incident surface 131 of the light guide plate 13. The light guide plate 13 is located between the reflective sheet 12 and the diffusion sheet 14, with the bottom surface 133 adjacent to the reflective sheet 12 and the light emitting surface 132 adjacent to the diffusion sheet 14. The prism sheet 15 is positioned above the diffusion sheet 14. When light rays produced by the light sources 11 enter the light guide plate 13, the light guide plate 13 redirects the light rays. Some of the light rays escape through the bottom surface 133 towards the reflective sheet 12, and are reflected back into the light guide plate 13 by the reflective sheet 12. Thereby, the efficiency of utilization of light energy is increased. The diffusion sheet 14 diffuses the light rays emitted from the light emitting surface 131 of the light guide plate 13 to make a brightness of the light rays more uniform. The prism sheet 15 collimates the light rays emitted from the diffusion sheet 14, thereby improving the brightness of light illumination provided by the backlight module 10.

Each point light source 11 is, for example, a light emitting diode. Each point light source 11 generally emits light over a limited range of angles only. In addition, a refractive index of the light guide plate 13 is greater than that of air between the point light sources 11 and the light incident surface 131. Therefore light rays from each light source 11 can enter the light incident surface 131 in a direction perpendicular to the light incident surface 131 and in directions somewhat oblique to the perpendicular direction. However, light beams that reach the light incident surface 131 at sharp oblique angles are liable to be reflected off the light incident surface 131. For these reasons, as shown in FIG. 2, in general a plurality of alternate bright areas tends to be generated in a region of the light guide plate 13 adjacent to the light incident surface 131. That is, a distribution of light emitting from the light emitting surface 132 is not uniform.

Referring to FIG. 3, this shows a typical means employed to overcome the above-described problems. A plurality of V-shaped cutouts 134 is configured on the light incident surface 131 of a light guide plate 13′ according to the positions of the light sources 11. However, the V-shaped cutouts 134 diffuse each of the incident light rays once only. In at least some cases, the V-shaped cutouts 134 cannot completely eliminate the occurrence of bright areas and dark areas adjacent to the light incident surface 131.

Therefore, what is needed is a light guide plate that can increase uniformity of brightness distribution adjacent to a light incident surface thereof, and a backlight module using such light guide plate.

### SUMMARY

A light guide plate according to a preferred embodiment of the present invention includes a light incident surface, a light emitting surface adjacent to the light incident surface, and a light diffusing cutout. The light diffusing cutout is defined in the light guide plate near the light incident surface.

A backlight module according to another preferred embodiment of the invention includes a light source, and a light guide plate. The light guide plate includes a light incident surface, a light emitting surface and a light diffusing cutout. The light source faces the light incident surface. The light emitting surface is adjacent to the light incident surface. The light diffusing cutout is defined in the light guide plate near the light incident surface and corresponding the light source.

Other advantages and novel features will become more apparent in the following detailed description when taken in conjunction with the accompanying drawings.

### BRIEF DESCRIPTION OF THE DRAWINGS

FIG. 1 is a schematic, exploded, isometric view of a conventional backlight module, the backlight module including a plurality of light sources and a light guide plate;

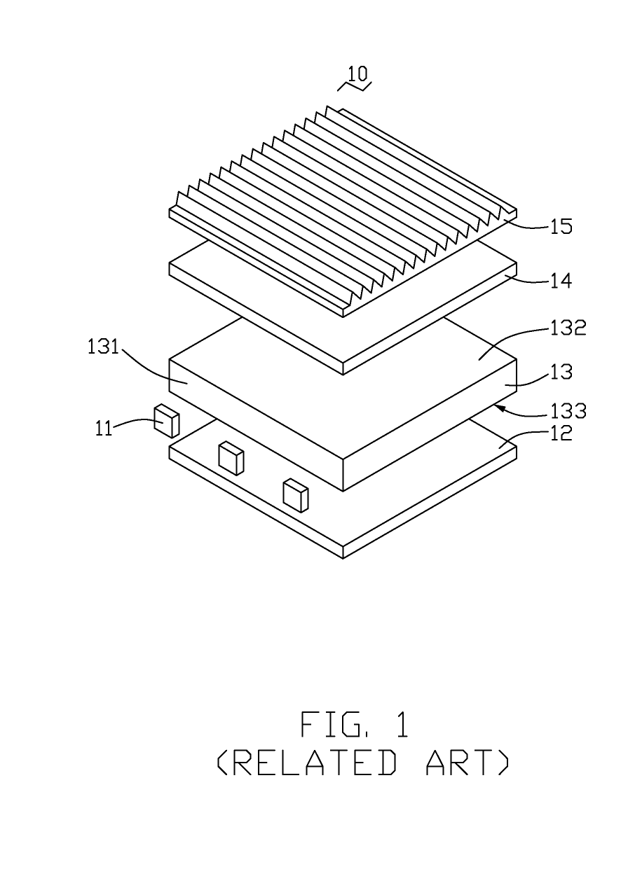

FIG. 2 is a schematic, top plan view of the light sources and the light guide plate of the backlight module of FIG. 1, showing essential light ray paths from the light sources projecting into the light guide plate;

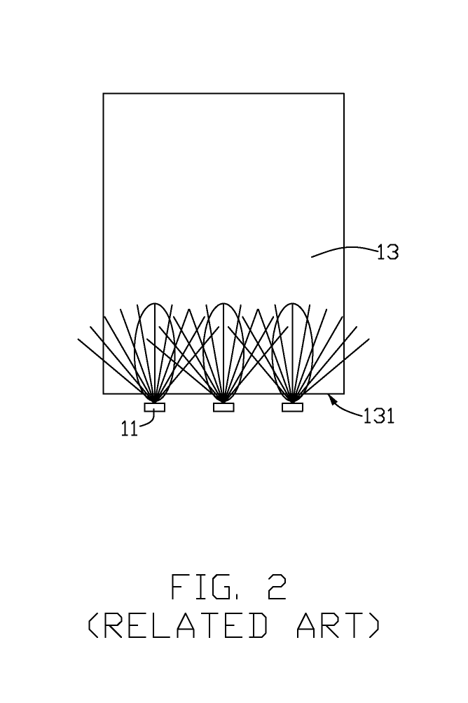

FIG. 3 is a schematic, isometric view of light sources and a light guide plate of another conventional backlight module, the light guide plate having a plurality of V-shaped cutouts on a light incident surface thereof;

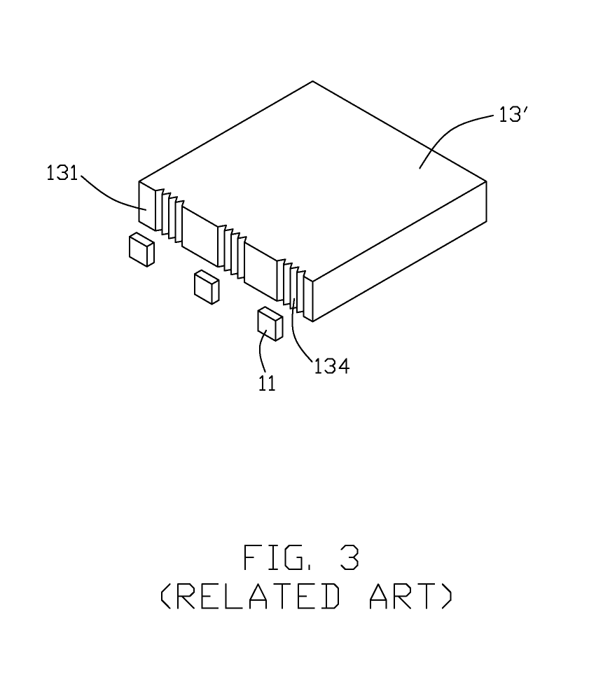

FIG. 4 is a schematic, top plan view of a light guide plate and a plurality of light sources of a backlight module according to a first preferred embodiment of the present invention;

FIG. 5 is an enlarged view of one of the light sources and part of the light guide plate of the backlight module of FIG. 4, showing refraction of essential light ray paths in the light guide plate;

FIG. 6 is similar to FIG. 5, but showing a corresponding view in the case of a backlight module according to a second preferred embodiment of the present invention;

FIG. 7 is similar to FIG. 5, but showing a corresponding view in the case of a backlight module according to a third preferred embodiment of the present invention; and

FIG. 8 is similar to FIG. 5, but showing a corresponding view in the case of a backlight module according to a fourth preferred embodiment of the present invention.

### DETAILED DESCRIPTION OF THE PREFERRED EMBODIMENTS

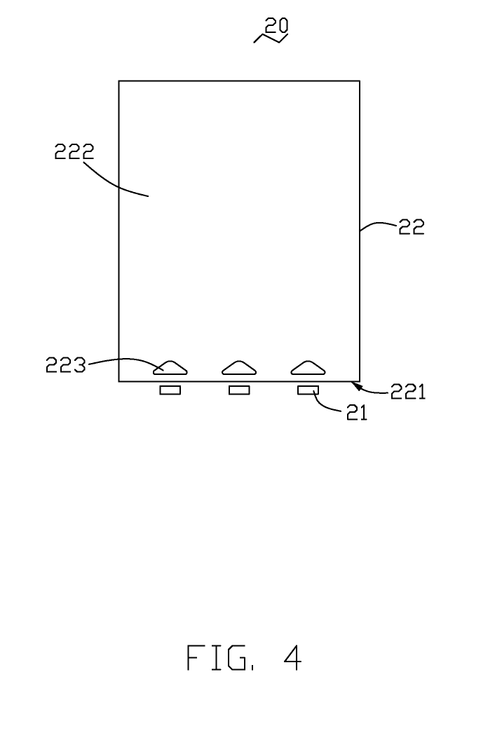

Referring to FIG. 4, a backlight module 20 according to a first preferred embodiment of the present invention is shown. The backlight module 20 includes a plurality of light sources 21 and a light guide plate 22. Each light source 21 can be a light emitting diode (LED). The light guide plate 22 includes a light incident surface 221, a light emitting surface 222, and a plurality of light diffusing cutouts 223. The light incident surface 221 faces the light sources 21. The light emitting surface 222 adjoins the light incident surface 221. The light diffusing cutouts 223 are located in the light guide plate 22 near the light incident surface 221, in one-to-one correspondence with the light sources 21. The light diffusing cutouts 223 span from the light emitting surface 221 either partially or fully through a thickness of the light guide plate 22. In the first embodiment, a horizontal cross-section of each light diffusing cutout 223 defines an approximately triangular shape.

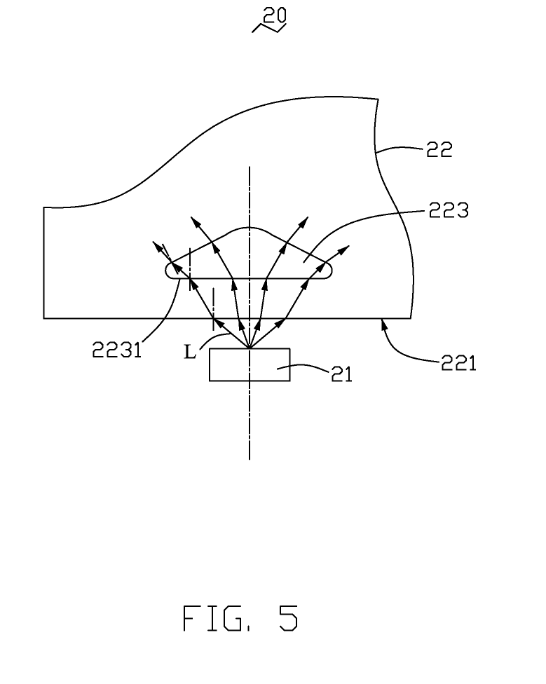

Referring also to FIG. 5, when the backlight module 20 is in use, light from the light sources 21 enters the light guide plate 22 and passes through the light diffusing cutouts 223. For example, when a light ray L passes into one of the light diffusing cutouts 223 through a sidewall 2231 thereof, because the refractive index of air in the light diffusing cutout 223 is less than a refractive index of a material of the light guide plate 22, the light ray L is refracted away from a plane normal to the light incident surface 221. Afterwards, when the light ray L exits the light diffusing cutout 223 through another sidewall (not labeled) thereof, the light ray L is refracted slightly towards the plane normal to the light incident surface 221. Nevertheless, because the other sidewall is oblique relative to the light incident surface 221, the light ray L overall undergoes a divergence from the plane normal to the light incident surface 221. That is, the light ray L is diffused toward what would otherwise be a dark area in the light guide plate 22. Thus in an area of the light guide plate 22 adjacent to the light incident surface 221, a uniformity of distribution of brightness is increased.

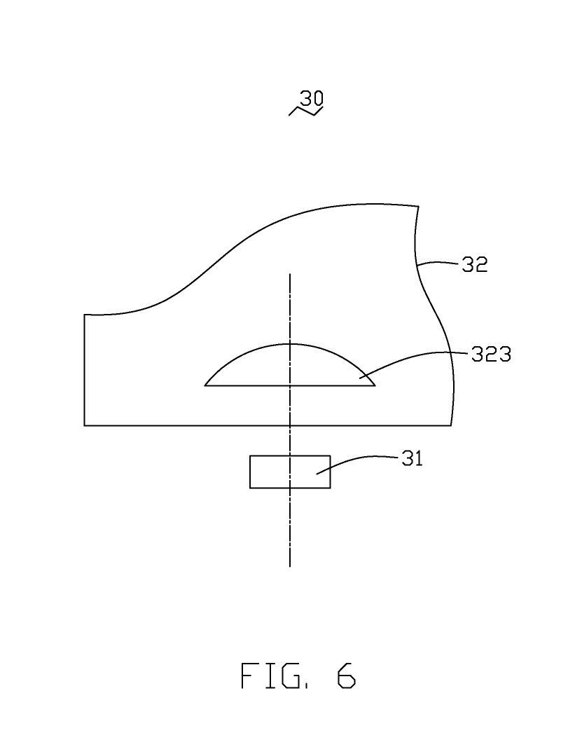

Referring to FIG. 6, a backlight module 30 according to a second preferred embodiment of the present invention is shown. The backlight module 30 is substantially the same as the backlight module 20 of the first embodiment, except that the backlight module 30 includes a plurality of light sources 31, and a light guide plate 32 having a plurality of light diffusing cutouts 323. A horizontal cross-section of each light diffusing cutout 323 defines a segment shape.

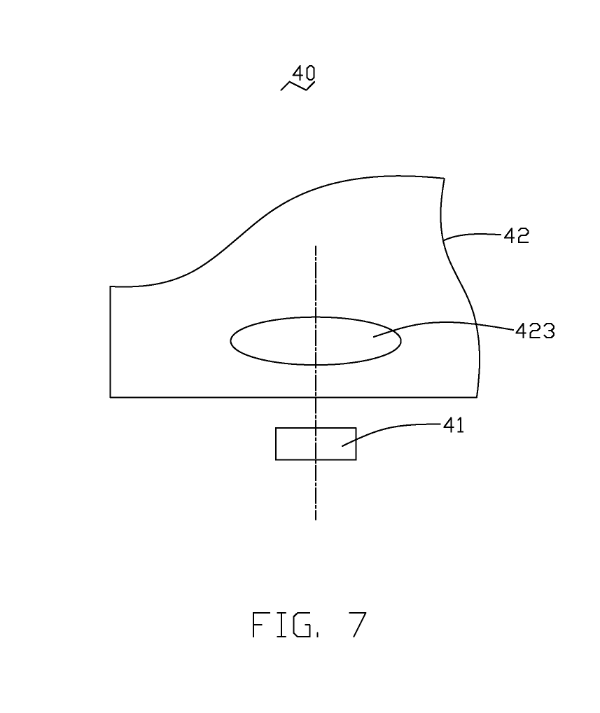

Referring to FIG. 7, a backlight module 40 according to a third preferred embodiment of the present invention is shown. The backlight module 40 is substantially the same as the backlight module 20 of the first embodiment, except that the backlight module 40 includes a plurality of light sources 41, and a light guide plate 42 having a plurality of light diffusing cutouts 423. A horizontal cross-section of each light diffusing cutout 423 defines an elliptical shape.

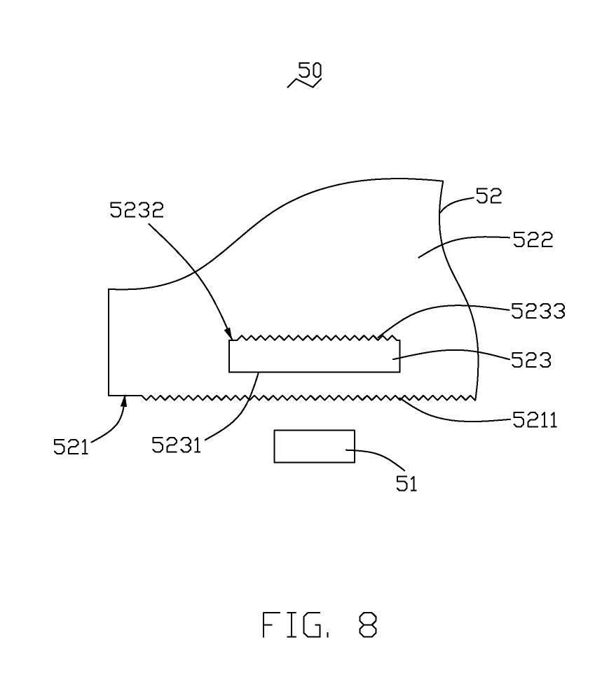

Referring to FIG. 8, a backlight module 50 according to a fourth preferred embodiment of the present invention is shown. The backlight module 50 includes a plurality of light sources 51 and a light guide plate 52. The light guide plate 52 includes a light incident surface 521, a light emitting surface 522, and a plurality of light diffusing cutouts 523 located in one-to-one correspondence with the light sources 51. A horizontal cross-section of each light diffusing cutout 523 defines an approximately rectangular shape. The light incident surface 521 includes a plurality of first microstructures 5211. In addition, each light diffusing cutout 523 has a first sidewall 5231 nearest to the incident surface 521, a second sidewall 5232 facing the first sidewall 5231, and a plurality of second microstructures 5233 formed on the second sidewall 5232. In the illustrated embodiment, the first microstructures 5211 and the second microstructures 5233 are V-shaped protrusions. In any of various alternative embodiments, for example, the first microstructures 5211 can be selected from the group consisting of trapezoid-shaped grooves, trapezoid-shaped protrusions, V-shaped grooves, V-shaped protrusions, arc-shaped grooves, arc-shaped protrusions, U-shaped grooves, and U-shaped protrusions. Similarly, the second microstructures 5233 can for example be selected from the group consisting of U-shaped protrusions and arc-shaped protrusions. When the light passes through the first microstructures 5211 and the second microstructures 5232, the light can be diffused toward what would otherwise be dark areas in the light guide plate 52. Thereby, a uniformity of brightness distribution of the light guide plate 52 is increased.

In addition, the inventive light guide plate and backlight module are not limited to the embodiments described above. For example, the first microstructures 5211 may be employed without having any second microstructures 5232; or the second microstructures 5232 may be employed without having any first microstructures 5211. The second sidewall 5232 of each light diffusing cutout 523 may be oriented obliquely relative to the light incident surface 521. Any of the light diffusing cutouts may be filled with material that has a lower refractive index than that of a material of the light guide plate. A size of each light diffusing cutout may be configured according to the corresponding light source, and/or according to other characteristics of the backlight module in which the light guide plate is to be used.

While various preferred and exemplary embodiments have been described, the embodiments can be still further modified within the spirit and scope of this disclosure. This application is therefore intended to cover any variations, uses, or adaptations of the embodiments using the general principles of the invention as claimed. Further, this application is intended to cover such departures from the present disclosure as come within known or customary practice in the art to which the invention pertains and which fall within the limits of the appended claims or equivalents thereof.

What is claimed is:

1. A light guide plate comprising:
a light incident surface;
a light emitting surface adjacent to the light incident surface; and
a light diffusing cutout defined near the light incident surface.

2. The light guide plate as described in claim 1, wherein the light diffusing cutout spans from the light emitting surface either partially or fully through a thickness of the light guide plate.

3. The light guide plate as described in claim 1, wherein a horizontal cross-section of the light diffusing cutout defines a shape selected from the group consisting of generally triangular, polygonal, sector-shaped, and elliptical.

4. The light guide plate as described in claim 1, wherein the light diffusing cutout has a first sidewall adjacent to the incident surface, a second sidewall facing the first sidewall, and a plurality of first microstructures formed on the second sidewall.

5. The light guide plate as described in claim 4, wherein the first microstructures are selected from the group consisting of V-shaped protrusions, U-shaped protrusions, and arc-shaped protrusions.

6. The light guide plate as described in claim 1, further comprising a plurality of microstructures formed on the light incident surface.

7. The light guide plate as described in claim 6, wherein the microstructures comprise items selected from the group consisting of trapezoid-shaped grooves, trapezoid-shaped protrusions, V-shaped grooves, V-shaped protrusions, arc-shaped grooves, arc-shaped protrusions, U-shaped grooves, and U-shaped protrusions.

8. A backlight module comprising:
a light source; and
a light guide plate, the light guide plate including:
a light incident surface, the light source facing the light incident surface;
a light emitting surface adjacent to the light incident surface; and
a light diffusing cutout defined near the light incident surface and corresponding the light source.

9. The backlight module as described in claim 8, wherein the light source is a light emitting diode.

10. The backlight module as described in claim 8, wherein the light diffusing cutout spans from the light emitting surface either partially or fully through a thickness of the light guide plate.

11. The backlight module as described in claim 8, wherein a horizontal cross-section of the light diffusing cutout defines a shape selected from the group consisting of generally triangular, polygonal, sector-shaped, and elliptical.

12. The backlight module as described in claim 8, wherein the light diffusing cutout has a first sidewall adjacent to the incident surface, a second sidewall facing the first sidewall, and a plurality of first microstructures formed on the second sidewall.

13. The backlight module as described in claim 12, where wherein the first microstructures are selected from the group consisting of V-shaped protrusions, U-shaped protrusions, and arc-shaped protrusions.

14. The light guide plate as described in claim 8, further comprising a plurality of microstructures formed the light incident surface corresponding the light source.

15. The backlight module as described in claim 1 4, wherein the microstructures comprise items selected from the group consisting of trapezoid-shaped grooves, trapezoid-shaped protrusions, V-shaped grooves, V-shaped protrusions, arc-shaped grooves, arc-shaped protrusions, U-shaped grooves, and U-shaped protrusions.
